(19) United States
(12) Patent Application Publication
(10) Pub. No.: US 2005/0276208 A1
(43) Pub. Date: Dec. 15, 2005

(54) Optical pickup adjusting apparatus and optical pickup adjusting method

(76) Inventors: Yasuhisa Miyata, Saitama-ken (JP); Masahiro Nakahashi, Saitama-ken (JP); Nobuo Tosa, Saitama-ken (JP)

Correspondence Address: ARENT FOX PLLC, 1050 CONNECTICUT AVENUE, N.W., SUITE 400, WASHINGTON, DC, 20036, US

(21) Appl. No.: 11/147,393

(22) Filed: Jun. 8, 2005

(30) Foreign Application Priority Data
Jun. 9, 2004 (JP) 2004-171141

(51) Int. Cl. G11B 7/00; G11B 7/135

(52) U.S. Cl. 369/112.23; 369/112.01; 369/112.24

(57) ABSTRACT

It is an object of the present invention to adjust an optical pickup without using an optical disc. An optical axis adjusting apparatus of the present invention comprises: a light receiving unit having a half mirror surface located at a position adapted to mount an optical disc and also having a photo-detector; a signal processing unit for generating a focus error signal from a detection signal outputted from the light receiving unit, and for generating another focus error signal from another detection signal outputted from a photo-detector of an optical pickup; and a control unit for controlling the posture of an actuator of an objective lens of the optical pickup and for generating adjustment signals for adjusting the optical pickup, in accordance with the focus error signal.

### BACKGROUND OF THE INVENTION

The present invention relates to an optical pickup adjusting apparatus and an optical pickup adjusting method.

The present application claims priority from Japanese Application No. 2004-171141, the disclosure of which is incorporated herein by reference.

FIG. 1 is a perspective view schematically showing a general structure of an optical pickup P. As shown in FIG. 1, the optical pickup P comprises: a laser diode (a laser light source) LD1 (for use with DVD: Digital Versatile Disc) and another laser diode (a laser light source) LD2 (for use with CD: Compact Disc), which are provided for outputting laser beams having different wavelengths; half mirrors 1, 2 and a mirror 3 which are provided for guiding a light beam b1 emitted from the laser diode LD1 or the laser diode LD2 along a predetermined path; a collimator lens 4 for converting the emitted light beam b1 into a collimated light beam; an objective lens 5 which is controlled in its posture by an actuator to apply the light beam to an optical disc D; a multi-lens 6 which is provided such that a reflected light beam b2 from the optical disc D can be incident thereof by way of the objective lens 5, the collimator lens 4, the mirror 3, and the half mirror 2; a light receiving element 7 such as a photo-detector or an optical electronics IC for receiving the reflected light beam b2 focused by the multi-lens 6 so as to read out information.

Such an optical pickup P may be manufactured in a process comprising the steps of: adjusting the posture of an actuator which actuates the objective lens 5 (return journey optical axis adjustment), which adjustment is performed by using a beam spot adjusting device prior to attaching the optical pickup P to a player or a recorder; adjusting the focus of the multi-lens 6 and the position of the photo-detector 7 by using an optical axis adjusting device (adjusting the optical axis of a light receiving unit); and adjusting the optical axis of the laser diode LD2 (which is for use with CD) by using the optical axis adjusting device after adjusting the focus of the multi-lens 6 and the position of the photo-detector 7 (as disclosed in Japanese Unexamined Patent Application Publication No. 2002-133708).

FIG. 2A is an explanatory block diagram showing an entire structure of a conventional optical axis adjusting apparatus 10, FIG. 2B is also an explanatory block diagram showing some important portions of the conventional optical axis adjusting apparatus. As shown, the conventional optical axis adjusting apparatus 10 is provided for performing the above-mentioned various adjustments by using an optical pickup P to actually apply a laser beam to an optical disc D, and comprises: a disc drive 10A for rotationally driving an optical disc D (for use in adjustment); a pickup control circuit 10B for controlling the disc drive 10A and an actuator 5A (for actuating the objective lens 5) in the optical-pickup P; a signal processing circuit 10C for processing disc signal detected by the photo-detector 7 of the optical pickup P; a measurement device 10D which analyzes the disc signal processed by the signal processing circuit 10C, and analyzes the focus and optical axis position of the reflected beam b2 (refer to FIG. 1) inputted into the photo-detector 7, by virtue of a jitter meter or an oscilloscope; and a control unit (which is in fact a personal computer) 10E for use in judging if an adjusted optical pickup is in a good condition in accordance with the analysis results provided by the measurement device 10D and for producing adjustment data.

An optical axis adjustment of the optical pickup P using the optical axis adjustment apparatus 10 can be carried out in accordance with the following procedure.

Namely, the optical pickup P with its actuator 5A adjusted in posture by the beam spot adjusting device (return journey optical axis adjustment) is set at an inspection position of the optical axis adjusting apparatus 10, and connected to a power supply circuit (not shown). Meanwhile, the actuator 5A is connected to the pickup control circuit 10B, and the photo-detector 7 is connected to the signal processing circuit 10C.

At first, the disc D is turned and the laser diode LD 1 (which is for use with DVD) is caused to emit a light beam. Then, once the photo-detector 7 receives a reflected light beam b2 from the disc D and outputs a disc signal, the disc signal is fed to the signal processing circuit 10C. The signal processing circuit 10C processes the disc signal fed from the photo-detector 7, and produces a drive control signal for controlling the disc drive 10A and a posture control signal for controlling the posture of the actuator 5A. Further, the pickup control circuit 10B performs a drive control for controlling the disc drive 10A and a posture control for controlling the posture of the objective lens 5 by virtue of the actuator 5A, in accordance with the drive control signal and the posture control signal.

Thus, after the pickup control circuit 10B performs the drive control for controlling the disc drive 10A and the posture control for controlling the posture of the objective lens 5 by virtue of the actuator 5A, once the photo-detector 7 outputs a disc signal upon receiving the reflected light beam b2, the signal processing circuit 10C will process measurement signal with respect to the disc signal.

Then, based on the disc signal processed in the measurement signal processing by the signal processing circuit 10C, the measurement device 10D analyzes the focus and optical axis position of the reflected light beam b2 inputted into the photo-detector 7.

Afterwards, the control unit 10E evaluates a high frequency characteristic of the disc signal in accordance with the analysis results provided by the measurement device 10D, so as to judge whether it is necessary to perform an optical axis adjustment, i.e., to determine whether it is necessary to adjust the focus of the multi-lens 6 and the light receiving position of the photo-detector 7.

In this process, when the control unit 10E determines that it is necessary to adjust the focus of the multi-lens 6 and the light receiving position of the photo-detector 7, the control unit 10E continues to generate adjustment data.

Next, when the optical pickup P is adjusted manually, an operator (person) can slide the position of the multi-lens 6 of the optical-pickup P in z-axis direction, or move the photo-detector 7 in both x-axis direction and y-axis direction so as to effect fine adjustments in the respective directions, in accordance with the adjustment data shown in the display of the control unit 10E (personal computer PC). On the other hand, when the optical pickup P is adjusted automatically by an automatic adjusting device (not shown), the adjustment data can be fed to the automatic adjusting device from the control unit 10E, thereby effecting similar adjustments as fine as described above on the multi-lens 6 or the photo-detector 7.

In this way, after adjusting the focus of the multi-lens 6 and the light receiving position of the photo-detector 7, the foregoing procedure is repeated in this process until the control unit 10E determines that it is not necessary to adjust the focus of the multi-lens 6 and the light receiving position of the photo-detector 7.

Then, if the control unit 10E determines that it is not necessary to adjust the focus of the multi-lens 6 and the light receiving position of the photo-detector 7, it is allowed to terminate the process of adjusting the optical pickup P in relation to the laser diode LD 1 (which is for use with DVD).

Here, when the optical pickup P is also provided with the laser diode LD2 (which is for use with CD) as shown in FIG. 1, an optical axis adjusting apparatus for use with CD optical system is employed to analyze the disc signal outputted from the photo-detector 7 in the same procedure as described above, thereby adjusting the laser diode LD2 in accordance with the analysis results.

As discussed above, the conventional optical pickup adjusting apparatus operates to adjust the optical pickup P by actually applying an emitted light beam b1 from the optical pickup P to the disc D, and then detect a reflected light beam b2 reflected from the disc D, based on the following reasons.

That is, when the emitted light beam b1 emitted from the optical pickup P is reflected by a mirror, even if such an emitted light beam b1 is not focusing on the mirror (at this time information can not be actually read out from an optical disc), the reflected light beam b2 can still be focusing on the photo-detector 7. As a result, it is impossible to perform a normal adjustment.

In view of the above, when an actual optical disc such as DVD and CD is employed to adjust an optical pickup P, an optical pickup adjusting apparatus will be required to include: a disc drive device; a special drive circuit only for performing various controls such as a tracking control and a focusing control which are suitable to the optical pickup P (which is to be adjusted); and a measurement device for analyzing disc signal.

For this reason, the conventional optical pickup adjusting apparatus is required to change its drive circuit and its control program every time an optical pickup has been changed in its model, thus requiring an extremely large effort and cost at the time of starting the manufacture of a new product.

Moreover, in the above-described conventional optical pickup adjusting apparatus, the focus adjustment of the multi-lens 6, the position adjustment of the photo-detector 7, and the position adjustment of the laser diode LD 2 (which is for use with CD) have to be carried out in different steps independent from a step in which a beam spot adjusting device is used to adjust the posture of an actuator which actuates the objective lens 5 (return journey optical axis adjustment). As a result, it is difficult to simplify the optical pickup adjusting apparatus, nor is it possible to avoid the occurrence of errors among various adjusting steps.

Moreover, when an actual optical disc is used to adjust an optical pickup P, a possible deterioration of the optical disc can unfavorably affect the adjustment precision of the optical pickup adjusting apparatus, resulting in a situation that the disc quality greatly affects the adjustment precision.

### SUMMARY OF THE INVENTION

The present invention has been accomplished in order to solve the foregoing problems existing in the conventional optical pickup adjusting apparatus and the conventional adjustment method. Therefore, it is an object of the present invention to provide an improved optical pickup adjusting apparatus and an improved adjustment method which can perform a high precision adjustment using simplified equipment not involving the use of an actual optical disc.

To achieve the foregoing object, the optical pickup adjusting apparatus and the adjustment method of the present invention comprises at least the following features according to the following aspects.

According to one aspect of the present invention there is provided an apparatus for adjusting an optical pickup which includes: at least one laser light source; an objective lens for converging a light beam emitted from the laser light source; an actuator for adjusting a converging position based on the objective lens; a multi-lens allowing the focusing of a reflected light beam of the emitted light beam; a photo-detector receiving the reflected light beam passing through the multi-lens. The apparatus comprises: light receiving position adjusting means for adjusting a light receiving position of the photo-detector; a light receiving unit having a photo-detector for receiving the emitted light beam; a signal processing unit for respectively generating focus error signals indicating the focus position and the optical axis position of a light beam incident on the light receiving surface of each photo-detector, in accordance with detection signals fed from the photo-detector of the optical pickup and the photo-detector of the light receiving unit; and a control unit for outputting adjustment signals for adjusting the actuator and the light receiving position adjusting means in accordance with the focus error signals fed from the signal processing unit. In particular, the light receiving unit includes: a half mirror member whose half mirror surface is set at a predetermined converging position of the objective lens; and an image formation optical system which allows the image of the half mirror surface to be formed on the light receiving surface of the photo-detector of the light receiving unit.

According to another aspect of the present invention there is provided a method for adjusting an optical pickup which includes: at least one laser light source; an objective lens for converging a light beam emitted from the laser light source; an actuator for adjusting a converging position based on the objective lens; a multi-lens allowing the focusing of a reflected light beam of the emitted light beam. The method involves the provisions of: light receiving position adjusting means for adjusting a light receiving position of the photo-detector; and a light receiving unit having a photo-detector for receiving the emitted light beam. In particular, the light receiving unit includes: a half mirror member whose half mirror surface is set at a predetermined converging position of the objective lens; and an image formation optical system which allows the image of the half mirror surface to be formed on the light receiving surface of the photo-detector of the light receiving unit. Specifically, the method comprises the steps of: adjusting the actuator and positioning the objective lens by virtue of detection signal fed from the photo-detector of the light receiving unit, in a manner such that the emitted light beam becomes focusing on the half mirror surface; and adjusting the light receiving position adjusting means by virtue of detection signal fed from the photo-detector of the optical pickup, in a manner such that a reflected light beam formed by reflecting the emitted light beam on the half mirror surface will be focusing on the light receiving surface of the photo-detector of the optical pickup and that the reflected light beam will be coincident with the optical axis of the light receiving surface.

### BRIEF DESCRIPTION OF THE DRAWINGS

These and other objects and advantages of the present invention will become clear from the following description with reference to the accompanying drawings, wherein:

FIG. 1 is a perspective view schematically showing a general structure of an optical pickup;

FIG. 2A is an explanatory block diagram showing an entire structure of a conventional optical axis adjusting apparatus, and FIG. 2B is an explanatory block diagram showing some important portions of the conventional optical axis adjusting apparatus;

FIG. 3 is an explanatory block diagram showing an entire structure of an optical axis adjusting apparatus according to an embodiment of the present invention;

FIG. 4 is an explanatory block diagram showing some important portions of the optical axis adjusting apparatus according to the embodiment of the present invention;

FIG. 5 is a flow chart showing a procedure (a method) for carrying out an optical axis adjustment using the optical axis adjusting apparatus according to the embodiment of the present invention;

FIGS. 6A to 6C are explanatory views showing the principle of focus adjustment using the optical axis adjusting apparatus of the present invention; and

FIG. 7 is an explanatory view showing the principle of an optical axis adjustment using the optical axis adjusting apparatus of the present invention.

### DETAILED DESCRIPTION OF THE PREFERRED EMBODIMENTS

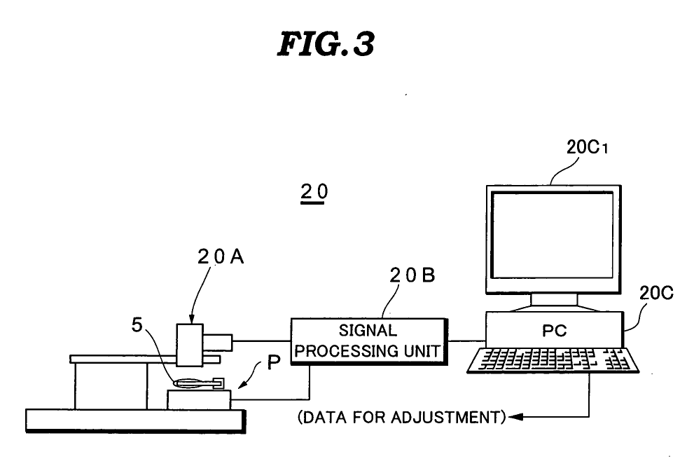

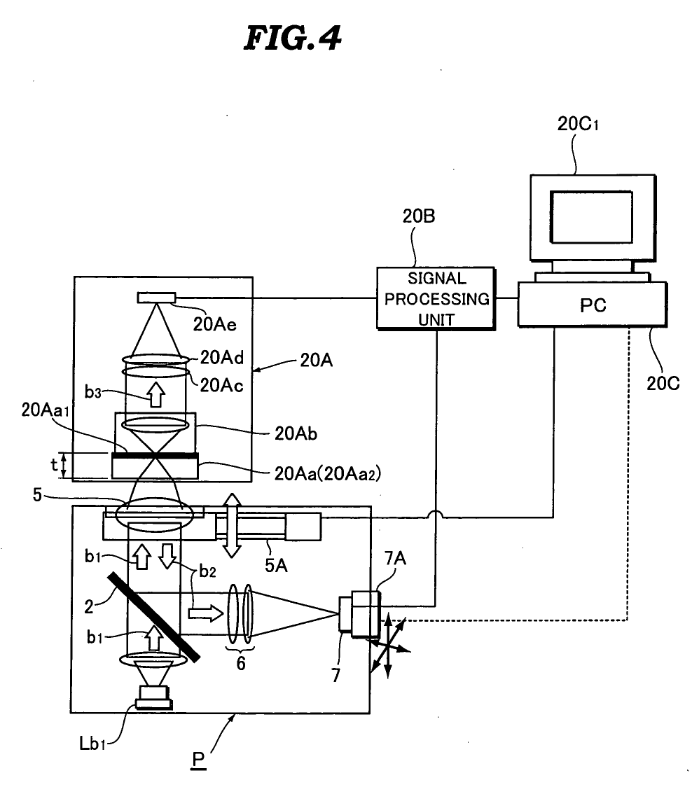

In the following, the present invention will be described with reference to the accompanying drawings (elements which are the same as those included in the above-described prior art will be represented by the same reference numerals and the repeated description will be omitted). FIGS. 3 and 4 are explanatory block diagrams showing an optical pickup adjusting apparatus 20 according to one embodiment of the present invention.

As shown in FIGS. 3 and 4, the optical pickup adjusting apparatus 20 comprises: a light receiving unit 20A which receives an emitted light beam b1 from the optical pickup P; a signal processing unit 20B for processing detection signal outputted from the light receiving unit 20A and detection signal outputted from the photo-detector 7 of the optical pickup P; and a control unit 20C (which is a personal computer having a monitor 20C₁) for controlling the posture of the actuator 5A of the optical pickup P, judging the result of adjustments performed on the optical pickup P, and producing adjustment signals.

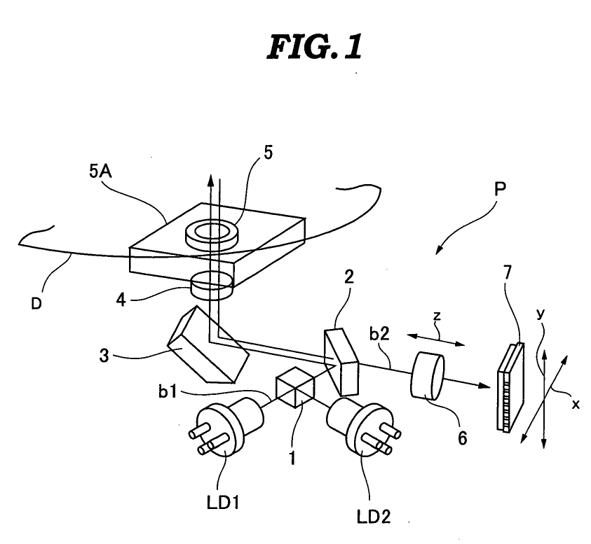

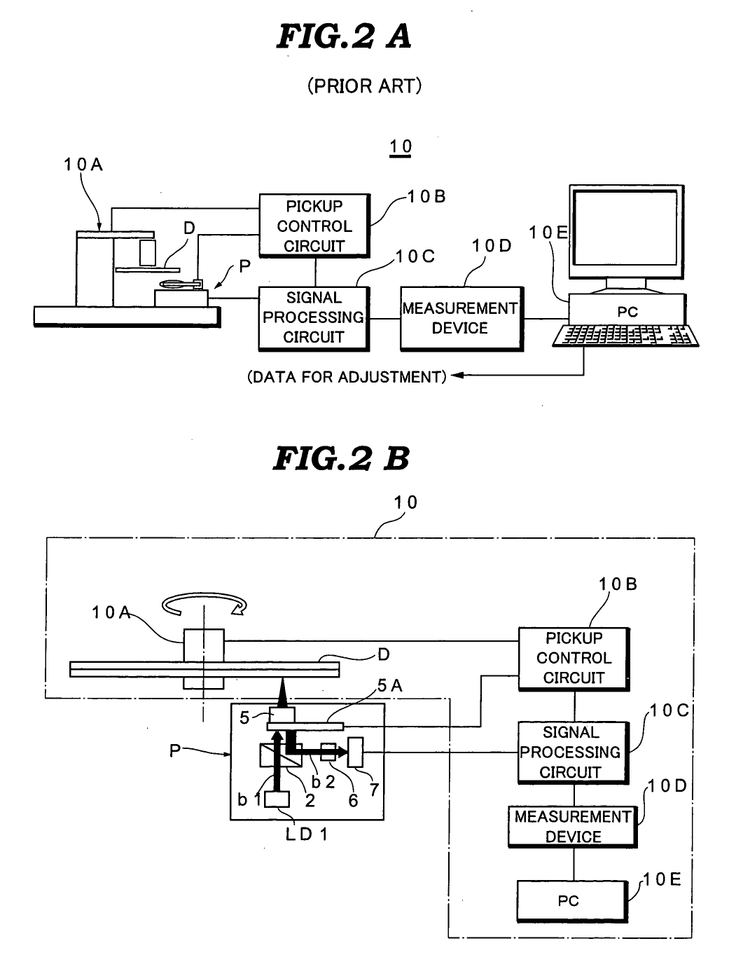

The light receiving unit 20A includes a half mirror member 20Aa having a half mirror surface 20Aa₁ positioned at a predetermined converging position of the light beam b1 emitted from the objective lens 5 of the optical pickup P (refer to FIG. 1); and an image formation optical system consisting of a high NA objective lens 20Ab facing the half mirror surface 20Aa₁, a collimator lens 20Ac, and a multi-lens (or a cylindrical lens) 20Ad; and a photo-detector 20Ae.

The half mirror member 20Aa is formed by forming a half mirror surface 20Aa₁ on a cover glass 20Aa₂ facing the objective lens 5 of the optical pickup P, and has a thickness of 6 mm.

The multi-lens 20Ad and the photo-detector 20Ae of the light receiving unit 20A are set in a manner such that when the light beam b1 being emitted from the optical pickup P to the light receiving unit 20A is focusing on the half mirror surface 20Aa₁, a light beam b3 passing through the half mirror surface 20Aa₁ will be focusing on the photo-detector 20Ae, so that the half mirror surface 20Aa₁ can have its image formed on the light receiving surface of the photo-detector 20Ae by way of an image formation optical system consisting of the high NA objective lens 20Ab, the collimator lens 20Ac, and the multi-lens (or a cylindrical lens) 20Ad.

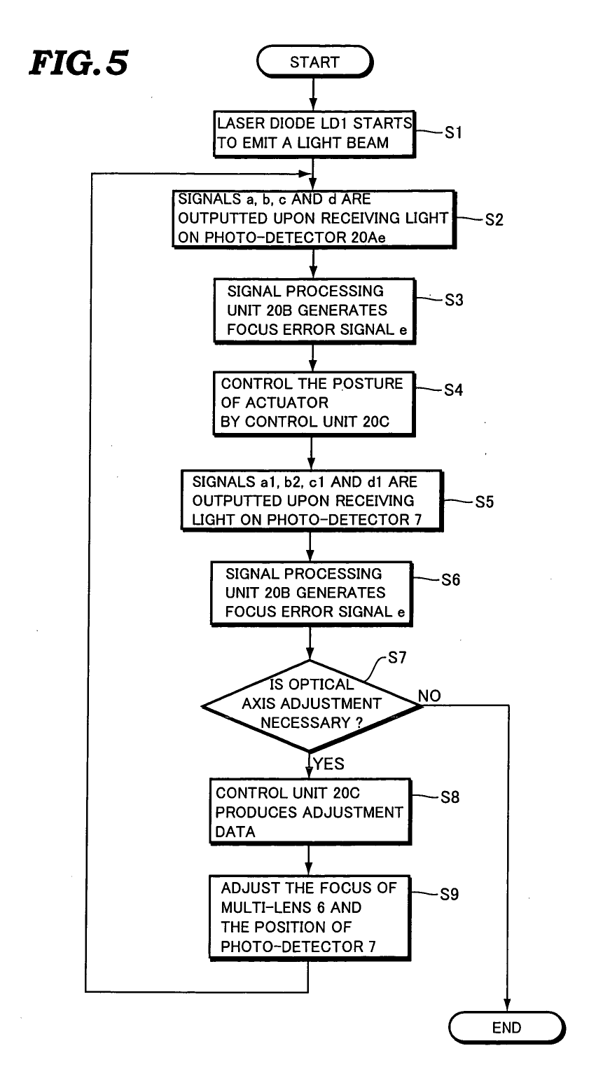

FIG. 5 is a flow chart showing a procedure (an adjustment method) for adjusting the optical axis of the optical pickup P using the optical pickup adjusting apparatus 20.

The optical pickup P whose optical axis is to be adjusted is set at an inspection position of the optical pickup adjusting apparatus 20, and connected to a power supply circuit (not shown) Meanwhile, the photo-detector 7 is connected to a signal processing unit 20B, while the actuator 5A is connected to the control unit 20C.

In this manner, the laser diode LD1 (which is for use with DVD) of the optical pickup P starts emitting a light beam b1. The emitted light beam b1 from the laser diode LD1 is then incident on the light receiving unit 20A (Step S1).

The emitted light beam b1 incident on the light receiving unit 20A is allowed to partially pass through the half mirror surface 20Aa₁ so as to form a passing light beam b3 which is then incident on the photo-detector 20Ae by way of the objective lens 20Ab, the collimator lens 20Ac and the multi-lens 20Ad.

Then, once the photo-detector 20Ae of the light receiving unit 20A receives the passing light beam b3, detection signals a, b, c, and d indicating various light receiving amounts on the divided light receiving surfaces of the photo-detector 20Ae will be outputted from the photo-detector 20Ae to the signal processing unit 20B (Step S2).

The signal processing unit 20B, based on the detection signals a, b, c, and d fed from the light receiving unit 20A, performs signal processing for generating a focus error signal e (Step S3) in accordance with a principle which will be explained later.

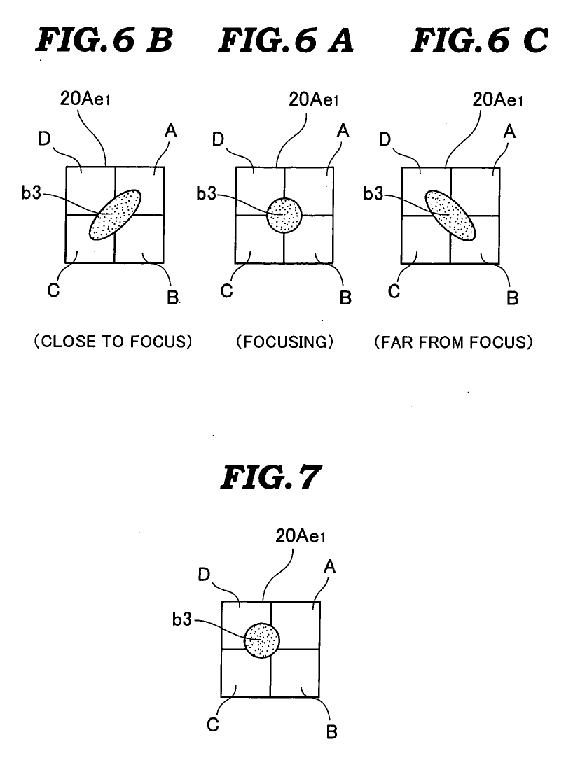

That is, as shown in FIGS. 6A to 6C, the photo-detector 20Ae is formed in a manner such that its light receiving surface 20Ae₁ is equally divided into four portions A, B, C, and D by virtue of two mutually orthogonal lines each passing through the center of the light receiving surface 20Ae₁, thereby outputting the detection signals a, b, c, and d corresponding to light receiving amounts on the divided portions A, B, C, and D to the signal processing unit 20B.

Subsequently, the signal processing unit 20B, based on the detection signals a, b, c, and d fed from the photo-detector 20Ae of the light receiving unit 20A, generates focus error signal e in accordance with an operational expression of e=(a+c)−(b+d).

Here, FIG. 6A shows that the light beam b3 passing through the half mirror 20Aa₁ is focusing on the photo-detector 20Ae of the light receiving unit 20A (namely, focusing on the half mirror surface 20Aa₁). At this time, the outputs of the various detection signals a, b, c, and d become equal to one another based on the above operational expression, so that an output of the focus error signal fed from the signal processing unit 20B becomes zero.

FIG. 6B shows that the focus of the light beam b3 stays in a position before the photo-detector 20Ae of the light receiving unit 20A (namely, focusing before the half mirror surface 20Aa₁), resulting in a situation in which an elliptical beam pattern extending in divided portions A and C is formed due to astigmatism. At this time, based on differences between various detection signals a, b, c, and d, a plus focus error signal e1 will be outputted from the signal processing unit 20B in accordance with the above operational expression.

FIG. 6C shows that the focus of the light beam b3 stays in a position behind the photo-detector 20Ae of the light receiving unit 20A (namely, focusing behind the half mirror surface 20Aa₁). At this time, based on differences between various photo/electro conversion signals a, b, c, and d, a minus focus error signal e will be outputted from the signal processing unit 20B in accordance with the above operational expression.

Moreover, FIG. 7 shows that the optical axis of the passing light beam b3 is not coincident with the center of the photo-detector 20Ae of the light receiving unit 20A. At this time, the focus error signals e having different outputs are outputted from the signal processing unit 20B to the control unit 20C, corresponding to the direction and the magnitude of deviation of the passing light beam b3.

The control unit 20C controls the posture of the actuator 5A of the optical pickup P in accordance with the focus error signal e fed from the signal processing unit 20B, so as to perform an adjustment in a manner such that the light beam b3 will be focusing on the photo-detector 20Ae of the light receiving unit 20A (namely, on the half mirror surface 20Aa₁) (Step S4) and its optical axis will be coincident with the center of the photo-detector 20Ae. In this way, by at first fixing the actuator at its correct position, it is possible to decide a standard optical path of the light beam b1.

On the other hand, the light beam b1 emitted from the optical pickup P is partially reflected by the half mirror surface 20Aa₁ towards the optical-pickup P, so that the reflected light beam b2 will be incident on the photo-detector 7 through the multi-lens 6. In this way, the detection signals a1, b1, c1, and d1 indicating the light receiving amounts on the four divided surfaces (which are the same as those on the photo-detector 20Ae) are outputted from the photo-detector 7 to the signal processing unit 20B (Step S5).

The signal processing unit 20B, based on the detection signals a1, b1, c1, and d1 fed from the photo-detector 7, performs signal processing for generating the focus error signal e1 (Step S6), by virtue of the same processing as the signal processing for processing the detection signals a, b, c, and d fed from the light receiving unit 20A.

Then, the control unit 20C, upon adjusting the posture of the actuator 5A of the optical pickup P, determines whether it is necessary to perform an optical axis adjustment, i.e., determines whether it is necessary to adjust the focus of the multi-lens 6 and the light receiving position of the photo-detector 7 (Step S7), in accordance with the focus error signal e1 fed from the signal processing unit 20B.

In step S7, when the output of the focus error signal e1 is not zero, the control unit 20C will generate data for adjusting the focus of the multi-lens 6 and data for adjusting the light receiving position of the photo-detector 7 (Step S8), corresponding to the magnitude of the output of the focus error signal e1.

When the adjustment of the optical pickup P is performed manually, an operator (human) can operate in accordance with an adjustment direction instructing display shown on the monitor 20C₁ of the control unit 20C, to adjust a light receiving position adjusting device, to move the photo-detector 7 in three directions of x, y, z axes with respect to the position of the multi-lens 6 of the optical pickup P, thereby effecting fine adjustments on these positions. On the other hand, when the adjustment of the optical pickup P is performed automatically by an automatic adjustment device, adjustment signals will be fed from the control unit 20C to the automatic adjustment device, thereby effecting the similar fine adjustments as described above on the multi-lens 6 or the photo-detector 7 (Step S9).

In this way, after adjusting the focus of the multi-lens 6 or the light receiving position of the photo-detector 7, the procedure from Step S5 to Step S9 is repeated until the control unit 20C determines that it is not necessary to adjust the focus of the multi-lens 6 or the light receiving position of the photo-detector 7 (Step S7).

Further, at Step S7, once the control unit 20C determines that it is not necessary to adjust the focus of the multi-lens 6 or the light receiving position of the photo-detector 7, the adjustment of the optical pickup P with respect to the laser diode LD1 (which is for use with DVD) is thus terminated.

Here, if the optical pickup P also includes the laser diode LD2 (which is for use with CD) as shown in FIG. 1, the laser diode LD1 (which is for use with DVD) is caused to emit a light beam, thereby adjusting the position of the laser diode LD2 (which is for use with CD) by the same procedure as described above.

As discussed above, the above-described optical pickup adjusting apparatus 20 performs focus adjustment and optical axis adjustment by receiving the light beam b1 emitted from the optical pickup P using the light receiving unit 20A having the half mirror 20Aa₁ disposed in the same position as would be occupied by an optical disc, without having to use an actual optical disc. As a result, it is no longer necessary to use a disc drive device, specific drive circuits for performing various controls such as a tracking control and an automatic focusing control corresponding to the optical pickup P (which is to be adjusted), and measurement device for analyzing disc signal, as would be needed in prior art.

In this way, it becomes possible to simplify the structure of an optical pickup adjusting apparatus, easily deal with (adjust) an optical pickup even if its model has been changed, thereby greatly reducing the labor and cost when starting to manufacture a new product.

Furthermore, with the use of the above-described optical pickup adjusting apparatus 20, it is allowed to employ only one apparatus in continuously performing the beam spot adjustment which adjusts the posture of the actuator 5A of the optical pickup P (return journey optical axis adjustment), the focus adjustment of the multi-lens 6, the position adjustment of the photo-detector 7, and the position adjustment of the laser diode LD2 (which is for use with CD). Therefore, it is possible to simplify related apparatus for use in adjusting the optical axis of an optical pickup, and to prevent the occurrence of errors between various adjusting steps. In addition, since it is possible to perform a desired adjustment without using an optical disc, it is allowed to avoid a problem that an adjustment precision is unfavorably affected by a deteriorated disc as would happen in the above-descried prior art.

In conclusion, the optical pickup adjusting apparatus according to the above-described embodiment of the present invention is an apparatus for adjusting an optical pickup which includes: at least one laser light source; an objective lens for converging a light beam emitted from the laser light source; an actuator for adjusting a converging position based on the objective lens; a multi-lens allowing the focusing of a reflected light beam of the emitted light beam; a photo-detector receiving the reflected light beam passing through the multi-lens. The apparatus comprises: light receiving position adjusting means for adjusting a light receiving position of the photo-detector; a light receiving unit having a photo-detector for receiving the emitted light beam; a signal processing unit for respectively generating focus error signals indicating the focus position and the optical axis position of a light beam incident on the light receiving surface of each photo-detector, in accordance with detection signals fed from the photo-detector of the optical pickup and the photo-detector of the light receiving unit; and a control unit for outputting adjustment signals for adjusting the actuator and the light receiving position adjusting means in accordance with the focus error signals fed from the signal processing unit. In particular, the light receiving unit includes: a half mirror member whose half mirror surface is set at a predetermined converging position of the objective lens; and an image formation optical system which allows the image of the half mirror surface to be formed on the light receiving surface of the photo-detector of the light receiving unit.

Further, the optical pickup adjusting method according to the above-described embodiment of the present invention is a method for adjusting an optical pickup which includes: at least one laser light source; an objective lens for converging a light beam emitted from the laser light source; an actuator for adjusting a converging position based on the objective lens; a multi-lens allowing the focusing of a reflected light beam of the emitted light beam. The method involves the provisions of: light receiving position adjusting means for adjusting a light receiving position of the photo-detector; and a light receiving unit having a photo-detector for receiving the emitted light beam. In particular, the light receiving unit includes: a half mirror member whose half mirror surface is set at a predetermined converging position of the objective lens; and an image formation optical system which allows the image of the half mirror surface to be formed on the light receiving surface of the photo-detector of the light receiving unit. Specifically, the method comprises the steps of: adjusting the actuator and positioning the objective lens by virtue of detection signal fed from the photo-detector of the light receiving unit, in a manner such that the emitted light beam becomes focusing on the half mirror surface; and adjusting the light receiving position adjusting means by virtue of detection signal fed from the photo-detector of the optical pickup, in a manner such that a reflected light beam formed by reflecting the emitted light beam on the half mirror surface will be focusing on the light receiving surface of the photo-detector of the optical pickup and that the reflected light beam will be coincident with the optical axis of the light receiving surface.

Accordingly, in using the apparatus or the method for adjusting an optical pickup according to the above-described embodiment of the present invention, an optical pickup (which is to be adjusted) is positioned at a predetermined position, and a light beam is outputted from a laser light source of the optical pickup towards a light receiving unit, thereby rendering it possible to control the posture of the actuator of the objective lens of the optical pickup, adjust the focus of the multi-lens, and adjust the optical axis of the photo-detector.

That is, the light beam being emitted from the laser light source of the optical pickup towards the light receiving unit is allowed to partially pass through the half-mirror of the light receiving unit so as to be received by the light receiving unit, while the detection signal is outputted from the light receiving unit to the signal processing unit.

The signal processing unit receives the detection signal outputted from the photo-detector of the light receiving unit, and generates a first focus error signal indicating the focus position and the optical axis position of the light beam incident on the photo-detector.

Then, based on the first focus error signal generated by the signal processing unit, the control unit controls the posture of the actuator of the objective lens of the optical pickup, so as to allow the light beam outputted from the optical pickup to be focusing on the half mirror surface and to make the light beam to be coincident with the optical axis of the photo-detector of the light receiving unit.

On the other hand, if the photo-detector of an optical pickup receives a light beam reflected from the half mirror surface of the light receiving unit, detection signal will be outputted from the photo-detector and fed into the signal processing unit, thereby generating from this detection signal a second focus error signal indicating the focus position and the optical axis position of a light beam incident on the photo-detector of the optical pickup.

Subsequently, the control unit, after controlling the posture of the actuator of the optical pickup in accordance with the first focus error signal, generates adjustment signals for performing a focus adjustment and an optical axis adjustment on the optical pickup in accordance with the second focus error signal.

In this way, it is possible to perform a focus adjustment based on a position adjustment of the multi-lens of the optical pickup and an optical axis adjustment based on a position adjustment of the photo-detector, through a manual operation performed by a human operator or through an automatic adjusting device, all in accordance with the adjustment signals generated above.

As discussed above, by virtue of the apparatus or the method for adjusting an optical pickup according to the above-described embodiment of the present invention, it is possible to perform an optical axis adjustment by receiving an emitted light beam from an optical pickup using a light receiving unit having the same structure as the optical pickup (which is to be adjusted) without using an optical disc. As a result, it is no longer necessary to use a disc drive device, specific drive circuits for performing various controls such as a tracking control and an automatic focusing control corresponding to the optical pickup P (which is to be adjusted), and measurement device for analyzing disc signal, as would be needed in prior art.

In this way, it is possible to simplify the structure of an optical pickup adjusting apparatus, easily deal with (adjust) an optical pickup even if its model has been changed, thereby greatly reducing the labor and cost when starting to manufacture a new product.

Furthermore, with the use of such an optical pickup adjusting apparatus, it is allowed to employ only one apparatus in continuously adjusting the posture of the actuator of the optical pickup, the focus of the multi-lens, and the posture of a photo-detector. Therefore, it is possible to simplify related equipment for use in adjusting the optical axis of an optical pickup, and to prevent the occurrence of errors between various adjusting steps.

Furthermore, with the use of such an optical pickup adjusting method, it is allowed to integrally carry out the steps of adjusting the posture of the actuator of the optical pickup, the focus of the multi-lens, and the posture of a photo-detector. Therefore, it is possible to simplify related equipment for use in adjusting the optical axis of an optical pickup, and to prevent the occurrence of errors between various adjusting steps.

Furthermore, since no optical disc is used, it is possible to avoid a trouble that an adjustment precision is unfavorably affected by a deteriorated optical disc.

Moreover, the light receiving unit is formed by forming a half mirror surface over a cover glass whose half mirror member is arranged opposite the objective lens of the optical pickup. Further, since an image formation optical system allowing the image of the half mirror surface to be formed on the light receiving surface of a photo-detector is provided with a high NA objective lens facing the half mirror surface, it is allowed to reduce the size of the light receiving unit (disposed for adjusting the optical pickup) in its optical axis direction.

While there has been described what are at present considered to be preferred embodiments of the present invention, it will be understood that various modifications may be made thereto, and it is intended that the appended claims cover all such modifications as fall within the true spirit and scope of the invention.

1. An apparatus for adjusting an optical pickup which optical pickup includes: at least one laser light source; an objective lens for converging a light beam emitted from the laser light source; an actuator for adjusting a converging position based on the objective lens; a multi-lens allowing the focusing of a reflected light beam of the emitted light beam; a photo-detector receiving the reflected light beam passing through the multi-lens,
said apparatus comprising:
light receiving position adjusting means for adjusting a light receiving position of the photo-detector of the optical pickup;
a light receiving unit having a photo-detector for receiving the emitted light beam;
a signal processing unit for respectively generating focus error signals indicating the focus position and the optical axis position of a light beam incident on the light receiving surface of each photo-detector, in accordance with detection signals fed from the photo-detector of the optical pickup and the photo-detector of the light receiving unit; and
a control unit for outputting adjustment signals for adjusting the actuator and the light receiving position adjusting means in accordance with the focus error signals fed from the signal processing unit;
wherein the light receiving unit includes: a half mirror member whose half mirror surface is set at a predetermined converging position of the objective lens; and an image formation optical system which allows the image of the half mirror surface to be formed on the light receiving surface of the photo-detector of the light receiving unit.

2. The apparatus according to claim 1, wherein the half mirror member is formed by forming the half mirror surface on a cover glass facing the objective lens.

3. The apparatus according to claim 1, wherein the image formation optical system has a high NA objective lens facing the half mirror surface.

4. The apparatus according to claim 1, wherein the control unit has monitor means, and an adjustment direction instructing display for adjusting the actuator and the light receiving position adjusting means is outputted to the monitor means in accordance with the adjustment signals.

5. The apparatus according to claim 1, wherein the actuator and/or the light receiving position adjusting means are automatically adjusted by virtue of the adjustment signals.

6. The apparatus according to claim 1, wherein one or both of the light receiving surfaces of each photo-detector is divided into a plurality of sub areas by mutually orthogonal lines each passing through the center of the light receiving surface, the detection signal from each sub area is outputted into the signal processing unit.

7. The apparatus according to claim 6, wherein the signal processing unit generates focus error signals by calculating output differences among the detection signals, in accordance with the respective detection signals from the respective sub areas.

8. A method for adjusting an optical pickup which includes: at least one laser light source; an objective lens for converging a light beam emitted from the laser light source; an actuator for adjusting a converging position based on the objective lens; a multi-lens allowing the focusing of a reflected light beam of the emitted light beam;
said method involving the provisions of:
light receiving position adjusting means for adjusting a light receiving position of the photo-detector; and
a light receiving unit having a photo-detector for receiving the emitted light beam;
wherein the light receiving unit includes: a half mirror member whose half mirror surface is set at a predetermined converging position of the objective lens; and an image formation optical system which allows the image of the half mirror surface to be formed on the light receiving surface of the photo-detector of the light receiving unit;
said method comprising the steps of:
adjusting the actuator and positioning the objective lens by virtue of detection signal fed from the photo-detector of the light receiving unit, in a manner such that the emitted light beam becomes focusing on the half mirror surface; and
adjusting the light receiving position adjusting means by virtue of detection signal fed from the photo-detector of the optical pickup, in a manner such that a reflected light beam formed by reflecting the emitted light beam on the half mirror surface will be focusing on the light receiving surface of the photo-detector of the optical pickup and that the reflected light beam will be coincident with the optical axis of the light receiving surface.

9. The method according to claim 8, further comprising the provisions of:
a signal processing unit for respectively generating focus error signals indicating the focus position and the optical axis position of a light beam incident on the light receiving surface of each photo-detector, in accordance with detection signals fed from the photo-detector of the optical pickup and the photo-detector of the light receiving unit; and
a control unit for outputting adjustment signals for adjusting the actuator and the light receiving position adjusting means in accordance with the focus error signals fed from the signal processing unit;
wherein the adjustment of the actuator is controlled by the adjustment signals.

10. The method according to claim 9, wherein the control unit has monitor means, and an adjustment direction instructing display for adjusting the light receiving position adjusting means is outputted to the monitor means by virtue of the adjustment signals.

11. The apparatus according to claim 2, wherein the image formation optical system has a high NA objective lens facing the half mirror surface.
